(19) United States
(12) Patent Application Publication
(10) Pub. No.: US 2026/0119340 A1
(43) Pub. Date: Apr. 30, 2026

(54) METHOD AND SYSTEM FOR UPGRADING AND OPTIMIZING FILE-BASED DATABASE, AND DEVICE AND STORAGE MEDIUM

(71) Applicant: SUZHOU METABRAIN INTELLIGENT TECHNOLOGY CO., LTD., Suzhou, Jiangsu (CN)

(72) Inventor: Bin HAN, Suzhou, Jiangsu (CN)

(21) Appl. No.: 19/157,466

(22) PCT Filed: Feb. 7, 2024
(86) PCT No.: PCT/CN2024/076548

§ 371 Date: Aug. 18, 2025

(30) Foreign Application Priority Data
Feb. 21, 2023 (CN) 202310141162.6

(51) Int. Cl. G06F 11/1446

(52) U.S. Cl. CPC G06F 11/1469

(57) ABSTRACT

The present application relates to the field of distributed storage systems, and provides a method and system for upgrading and optimizing a file-based database, and a device and a storage medium. The method comprises: issuing a node controller to each node by means of a master controller, installing and starting the node controller, and monitoring the state of the node controller in a heartbeat mode; formulating a database upgrading strategy according to a concurrent upgrading strategy of a distributed storage system; and according to the database upgrading strategy, performing online upgrading on a file-based database of each node by means of the node controller. According to the present application, online upgrading of a file-based database is achieved, and it is ensured that a normal read-write service can be provided for the outside during the database upgrading period; and a read-write service supporting both a new data structure and an old data structure is achieved, i.e., during the upgrading period of the whole distributed storage system, a normal read-write operation can be performed on the database regardless of whether a database operation interface has been upgraded.

### CROSS-REFERENCE TO RELATED APPLICATION

The present application claims priority to Chinese patent application No. 202310141162.6, entitled “METHOD AND SYSTEM FOR UPGRADING AND OPTIMIZING FILE-BASED DATABASE, AND DEVICE AND STORAGE MEDIUM”, filed on Feb. 21, 2023 before the China National Intellectual Property Administration, which is incorporated herein in its entirety by reference.

### TECHNICAL FIELD

The present application relates to the field of distributed file systems, in particular to a method, system, device and non-transitory readable storage medium for upgrading and optimizing file-based databases.

### BACKGROUND

Lightweight file-based databases have advantages, such as being portable, easy to operate, having good concurrent read performance, and being simple and efficient in storage. File-based databases can be accessed without any settings, that is, no system setting is required to directly access the database and obtain data information. Therefore, distributed storage systems generally use such databases to store alarms, caches, and temporary information. However, file-based databases also have apparent disadvantages: the performance of concurrent read and write operations of file-based databases is not ideal due to the locking mechanism for concurrent access, the database may be monopolized by write operations, causing other read and write operations to be blocked, and concurrent writes may even lead to database deadlocks; secondly, such file-based databases have incomplete support for the SQL (Structured Query Language, a database language with multiple functions such as data manipulation and data definition) standard, especially lacking operations for modifying database table fields. Due to the lack of standard commands for modifying database table fields, when upgrading such databases, the only way to realize the update of table fields is to first create a new table and then re-import the historical data. For the reasons mentioned above, in order to ensure the upgrade efficiency of file-based databases and database safety (the concurrence of write operations for the database upgrade process and normal write operations may lead to database deadlocks), it is common to upgrade file-based databases in an offline manner. This means that it is necessary to suspend read and write access to the database from the outside during the database upgrade period.

### SUMMARY

An aspect of some embodiments of the present application provides a method for upgrading and optimizing a file-based database, including: distributing, by a main controller, a node controller to each node, installing and activating the node controller on each node, and monitoring a state of each said node controller in a heartbeat manner; formulating a database upgrade strategy according to a concurrent upgrade strategy of a distributed storage system; and performing, by each said node controller, online upgrade on the file-based database of each node according to the database upgrade strategy.

In some embodiments, the method further includes triggering, by the main controller, different rollback strategies according to different upgrade phases.

In some embodiments, the triggering, by the main controller, different rollback strategies according to different upgrade phases includes: in response to an exception occurring during a database upgrade phase, replacing contents of a source database with a temporary database directly and blocking the upgrade of nodes in the storage system.

In some embodiments, the triggering, by the main controller, different rollback strategies according to different upgrade phases includes: in response to an exception occurring in the upgrade of nodes in the distributed storage system, triggering degradation, rolling back a table structure of the database to the table structure before the upgrade and retaining newly written data during the upgrade.

In some embodiments, the method further includes the triggering, by the main controller, different rollback strategies according to different upgrade phases includes: in response to an upgrade failure of a cluster of the distributed storage system, triggering a forced rollback, and forcing, by the main controller, databases of all nodes to roll back to the state before the upgrade.

In some embodiments, the performing, by each said node controller, online upgrade on the file-based database of each node according to the database upgrade strategy includes: setting an upgrade flag in the database, and triggering a database operation interface to redirect according to the upgrade flag to redirect all database operation commands to a redirection interface of the node controller for processing.

In some embodiments, the performing, by each said node controller, online upgrade on the file-based database of each node according to the database upgrade strategy includes: writing all data issued from redirection that is written during database upgrade into a data cache.

In some embodiments, the performing, by each said node controller, online upgrade on the file-based database of each node according to the database upgrade strategy includes: generating a temporary database by copying the file-based database, and providing data query services to the outside during the database upgrade by using the temporary database as a main database.

In some embodiments, the performing, by each said node controller, online upgrade on the file-based database of each node according to the database upgrade strategy includes: adjusting tables with changed data structures in a source database, and flushing the data in the data cache to the source database according to the adjusted data structures.

In some embodiments, the performing, by each said node controller, online upgrade on the file-based database of each node according to the database upgrade strategy includes: performing read and write tests on the source database and the tables with changed structures; and performing rollback directly by using the temporary database in response to the tests being abnormal.

In some embodiments, the performing, by each said node controller, online upgrade on the file-based database of each node according to the database upgrade strategy includes: directly reading and writing the source database by the node controller after the upgrade of the source database is completed.

In some embodiments, the performing, by each said node controller, online upgrade on the file-based database of each node according to the database upgrade strategy includes: removing, by the node controller, the upgrade flag after the upgrade of the file-based database is completed, and switching the database operation interface to a normal operation process.

In some embodiments, the method further includes: recording, by each said node controller, data information about the table structure of a new database and an old database, and converting, based on the information about the table structures of the new database and the old database, information into data information that meets requirements of the redirection interface for response.

In some embodiments, the method further includes: automatically switching, by the redirection interface of the node controller, between the temporary database and the source database according to the state of database upgrade.

In some embodiments, the method further includes: receiving, by the redirection interface of the node controller, data written from the outside, saving the data to the data cache, and assembling, by the redirection interface, the data in the database cache and the data in the temporary database to respond to external read operations.

In some embodiments, the method further includes: caching, by the data cache of the node controller, newly added data, and serializing the data cached according to the structure of the source database.

In some embodiments, the method further includes: upgrading, by an upgrade controller of the node controller, the data structure of the source database and updating data.

Another aspect of some embodiments of the present application provides a system for upgrading and optimizing a file-based database, including: a monitoring module, configured to distribute a node controller to each node by a main controller, install and activate each said node controller on each node, and monitor a state of each said node controller in a heartbeat manner; a strategy module, configured to formulate a database upgrade strategy according to a concurrent upgrade strategy of a distributed storage system; and an execution module, configured to perform, by each said node controller, online upgrade on the file-based database of each node according to the database upgrade strategy.

Yet another aspect of some embodiments of the present application provides a computer device, including: at least one processor; and a memory. The memory is stored with computer executable instructions that when executed by the processor, implement steps of the method described above.

Yet another aspect of some embodiments of the present application provides a non-transitory readable storage medium storing a computer program that when executed by a processor, implements steps of the method described above.

### BRIEF DESCRIPTION OF THE DRAWINGS

In order to describe technical solutions of the embodiments of the present disclosure or the related art more clearly, the accompanying drawings used in the illustration of the embodiments or the related art will be briefly introduced. Apparently, the accompanying drawings in the following explanation illustrate merely some embodiments of the present disclosure, and those skilled in the art may obtain other embodiments based on these accompanying drawings without paying any creative effort.

FIG. 1 is a schematic diagram of a method for upgrading and optimizing a file-based database provided by some embodiments of the present application;

FIG. 2 is a monitoring block diagram of a main controller provided by the present application;

FIG. 3 is a block diagram of a node controller provided by the present application;

FIG. 4 is a block diagram illustrating rollback strategies provided by the present application;

FIG. 5 is a schematic diagram of a system for upgrading and optimizing a file-based database provided by some embodiments of the present application;

FIG. 6 is a schematic hardware structural diagram of a computer device for upgrading and optimizing a file-based database provided by some embodiments of the present application; and

FIG. 7 is a schematic diagram of a non-transitory readable storage medium for upgrading and optimizing a file-based database provided by some embodiments of the present application.

### DETAILED DESCRIPTION OF THE EMBODIMENTS

To make the objects, technical solutions and advantages of the present application clearer, the present application will be further described in detail in combination with some specific embodiments and with reference to the accompanying drawings.

It should be noted that all expressions with “first” and “second” in some embodiments of the present application are intended to distinguish two different entities or parameters with the same name. It can be seen that “first” and “second” are only used for the convenience of expression and should not be understood as limitations on some embodiments of the present application, which will not be repeated in subsequent embodiments.

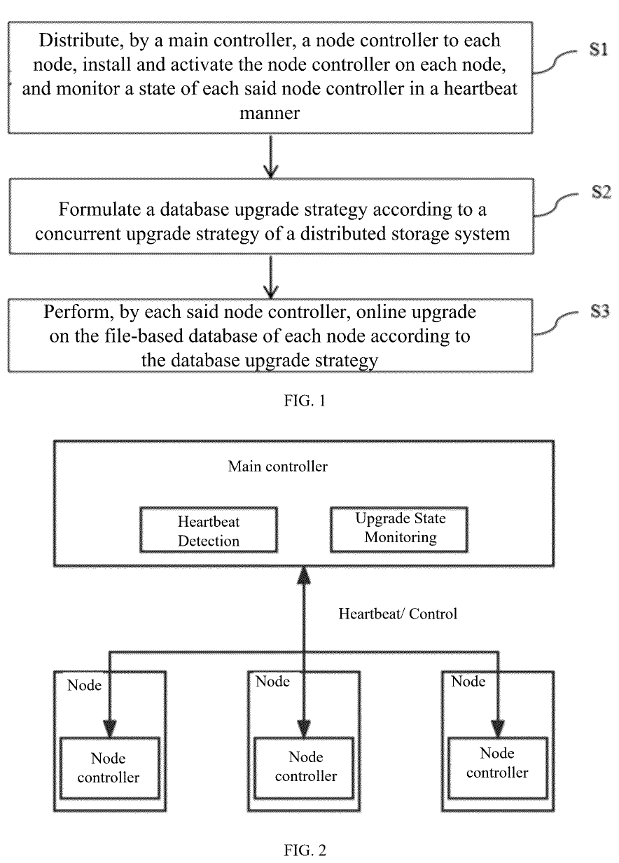

In a first aspect of the present application, an embodiment of a method for upgrading and optimizing a file-based database is proposed. FIG. 1 is a schematic diagram of the method for upgrading and optimizing a file-based database provided by some embodiments of the present application. As shown in FIG. 1, some embodiments of the present application include steps described below.

At S1, a main controller distributes a node controller to each node, the node controller is installed and activated on each node, and the main controller monitors the state of each node controller in a heartbeat manner.

At S2, a database upgrade strategy is formulated according to a concurrent upgrade strategy of the distributed storage system.

At S3, the node controller performs online upgrade of the file-based database of each node according to the database upgrade strategy.

In some embodiments of the present application, a database upgrade control module is incorporated, which is mainly composed of a main controller and node controller(s). The main controller is mainly responsible for an overall upgrade process of the clustered databases and the formulation of upgrade strategies. The node controller is mainly responsible for controlling the upgrade of the file-based database and ensuring that normal data read/write operations remain available during the database upgrade. The core of realizing the online upgrade of the file-based database lies in a data converter and a redirection interface in the node controller. The data converter and the redirection interface cooperate with each other to realize seamless querying for the external interface, that is, regardless of whether the external database interface has been upgraded, the redirection interface can ensure that data information with the correct structure can be obtained.

The main controller distributes the node controller to each node, the node controller is installed and activated on each node, and the main controller monitors the state of each node controller in a heartbeat manner. The main controller is mainly responsible for the online upgrade of databases during the online upgrade of the distributed storage system. By distributing the node controller to each node, installing and activating the node controller on each node and monitoring the state of each node controller in the heartbeat manner, the state of each node controller and the database upgrade progress of the node can be obtained in real time. FIG. 2 is a monitoring block diagram of the main controller provided by the present application.

The database upgrade strategy is formulated according to the concurrent upgrade strategy of the distributed storage system. The main controller formulates the database upgrade strategy according to the concurrent upgrade strategy of the distributed storage system, and executes the concurrent upgrade of databases of nodes. The upgrade of the storage system of a single node depends on the completion of the upgrade operation of the database of that node.

The online upgrade of the file-based database of each node is performed by the node controller according to the database upgrade strategy.

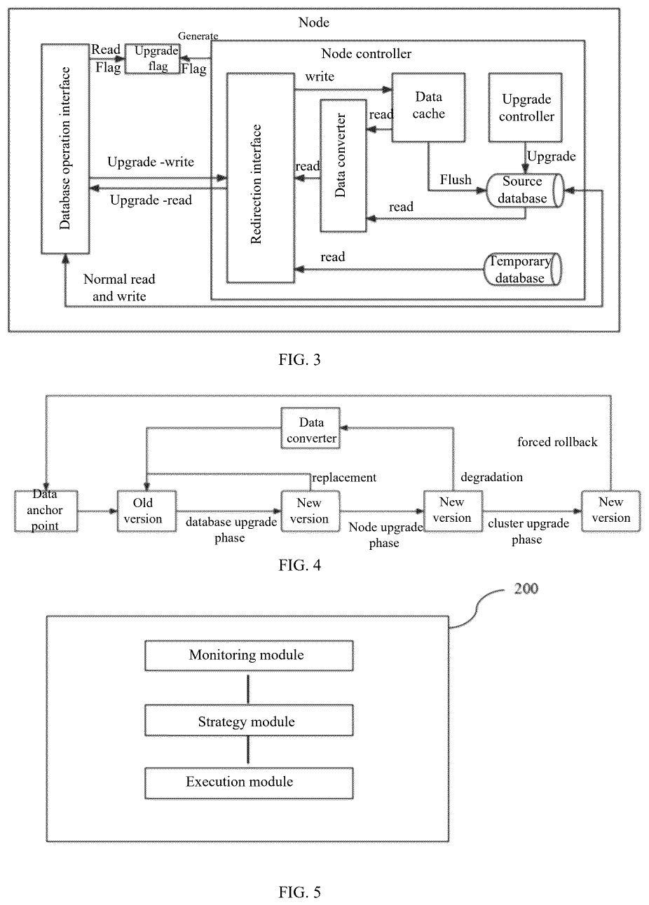

FIG. 3 is a block diagram of the node controller provided by the present application. As shown in FIG. 3, the node controller mainly includes a data converter, a redirection interface, a data cache and an upgrade controller. The data converter is mainly responsible for converting and outputting data according to the data structures of the new database and the old database. The data converter is also recorded with data information about the table structures of the new database and the old database. Based on the table structure information of the new database and the old database, the data converter converts the information into data information that meets the requirements of the redirection interface for response. The redirection interface is mainly responsible for external data reading/writing during the database upgrade. The redirection interface automatically switches between a temporary database and a source database according to the state of database upgrade. The redirection interface receives data written from the outside and saves the data to the data cache. Moreover, the redirection interface is also responsible for assembling the data in the database buffer and the data in the temporary database to respond to external read operations. The main functions of the data cache include: first, caching the write data issued from the redirection interface; second, providing a query function for cached data; third, flushing the cached data to the source database according to the upgrade state of the source database. The purposes of introducing the data cache are: avoiding the loss of newly written data during the database upgrade, and optimizing database performance. Since file-based databases are not friendly to concurrent writes, the data cache is introduced to effectively avoid concurrent writes during the database upgrade, thereby reducing the probability of database deadlocks and improving the efficiency of database upgrades. The upgrade controller is mainly responsible for upgrading the data structure of the source database and updating data.

In some embodiments, the step, in which the online upgrade of the file-based database of each node is performed by the node controller according to the database upgrade strategy, includes: setting an upgrade flag in the database, and triggering the database operation interface to redirect according to the upgrade flag so as to redirect all database operation commands to the redirection interface of the node controller for processing.

In some embodiments, the step, in which the online upgrade of the file-based database of each node is performed by the node controller according to the database upgrade strategy, includes: writing all data issued from redirection that is written during database upgrade into a data cache.

In some embodiments, the step, in which the online upgrade of the file-based database of each node is performed by the node controller according to the database upgrade strategy, includes: generating a temporary database by copying the file-based database, and providing data query services during the database upgrade by using the temporary database as the main database. In order to improve the efficiency of database upgrade and the availability of the database during database upgrade, the single file characteristic of the file-based database is used to copy and generate a temporary database, and the data in the temporary database is consistent with that in the source database. The temporary database is introduced for two reasons. The first reason is that the temporary database is used as the main database to provide data query services to the outside during the database upgrade, thereby ensuring the availability of the database during the upgrade. Since the source database is undergoing an upgrade at this time and a large number of write operations will block read operations during the upgrade, only the temporary database is chosen to provide query services to the outside, thereby ensuring that the external read performance of the database is not affected. The second reason is that the temporary database is served as a database backup, so that data can be recovered using the temporary database and the data cache if the upgrade of the source In some embodiments, the step, in which the online upgrade of the file-based database of each node is performed by the node controller according to the database upgrade strategy, includes: adjusting tables with changed data structures in the source database, and flushing the data in the data cache to the source database according to the new data structure. The upgrade of the source database follows the principle of minimal modification, and only tables with changed data structures are adjusted. After the upgrade of the source database is completed, the data in the data cache is flushed to the source database according to the new data structure.

In some embodiments, the step, in which the online upgrade of the file-based database of each node is performed by the node controller according to the database upgrade strategy, includes: performing read and write tests on the source database and tables with changed structures. If the test is abnormal, rollback is performed directly using the temporary database. Read and write tests are performed on the source database and the tables with changed structures. If the test is abnormal, it indicates that the database upgrade fails, and the temporary database is directly used for rollback.

In some embodiments, the step, in which the online upgrade of the file-based database of each node is performed by the node controller according to the database upgrade strategy, includes: directly reading and writing the source database by the node controller after the upgrade of the source database is completed.

In some embodiments, the step, in which the online upgrade of the file-based database of each node is performed by the node controller according to the database upgrade strategy, includes: in response to the upgrade of the file-based database being completed, removing the upgrade flag by the node controller, and switching the database operation interface to the normal operation process.

In some embodiments, the method further includes: recording information about the table structures of both of the new database and the old database by the node controller, and converting the information into data information that meets the requirements of the redirection interface for response based on the information about the table structures of the new database and the old database.

In some embodiments, the method further includes: automatically switching between the temporary database and the source database by the redirection interface of the node controller according to the database upgrade state.

In some embodiments, the method further includes: receiving data written from the outside by the redirection interface of the node controller, saving the data to the data cache, and assembling the data in the database buffer and the data in the temporary database by the redirection interface to respond to external read operations.

In some embodiments, the method further includes: caching newly added data by the data cache of the node controller, and serializing the cached data according to the structure of the source database.

In some embodiments, the method further includes: upgrading the data structure of the source database and updating data by the upgrade controller of the node controller.

In some embodiments, the method further includes: triggering different rollback strategies by the main controller according to different upgrade phases. The dynamic rollback strategies include: replacement, degradation, and forced rollback. Degradation refers to only rolling back the database table structure without rolling back data, that is, retaining the newly written data during the upgrade; forced rollback refers to performing forced rollback according to a data anchor point set by the main controller before the upgrade of the distributed storage system, and no new data is retained during the forced rollback. The main controller triggers different rollback strategies according to different upgrade phases.

FIG. 4 is a block diagram of the rollback strategies provided by the present application. As shown in FIG. 4, if an exception occurs during the database upgrade phase, replacement is triggered. The content of the source database is directly replaced with the temporary database, and the upgrade of the node storage system is blocked. If an exception occurs in the upgrade of a node in the node distributed storage system, degradation is triggered, the database table structure is rolled back to the database table structure before the upgrade, and the newly written data during the upgrade is retained. If the upgrade of the cluster of distributed storage system fails, the forced rollback is triggered, and the main controller forces databases of all nodes to roll back to the state before the upgrade.

In some embodiments, triggering different rollback strategies by the main controller according to different upgrade phases includes: in response to an exception occurring during the database upgrade phase, directly replacing the content of the source database with the temporary database and blocking the upgrade of the node storage system.

In some embodiments, triggering different rollback strategies by the main controller according to different upgrade phases includes: in response to an exception occurring in the upgrade of the node in the node distributed storage system, triggering degradation, that is, rolling back the database table structure to the database table structure before the upgrade, and retaining the newly written data during the upgrade.

In some embodiments, triggering different rollback strategies by the main controller according to different upgrade phases includes: in response to the upgrade failure of the cluster of the distributed storage system, triggering forced rollback, that is, the main controller forcing databases of all nodes to roll back to the state before the upgrade.

In some embodiments of the present application, the database upgrade controller can realize the online upgrade of the file-based database in the distributed storage system, that is, the read and write operations of the database are not affected during the upgrade of the distributed storage system; the main controller implements a dynamic rollback strategy, through which different database rollback strategies can be adopted according to different upgrade phases, thereby reducing the impact of database or upgrade failures on services; the data converter realizes the mutual conversion between the new and old structure data of the database, realizes the automatic switching between the new structure data and the old structure data on demand and responds to the outside, ensuring that the database can be normally queried or written by both the new interface and the old interface during the upgrade; the redirection interface realizes the normal reading and writing of external data during the upgrade of the distributed storage system. The data converter and the redirection interface cooperate with each other to realize the seamless connection of data query, that is, the redirection interface can automatically switch between the new data structure and the old data structure according to the upgrade state of the external interface and respond; the data cache is mainly used to cache newly added data and can serialize the cached data according to the structure of the source database; the upgrade controller can minimize operations of database upgrade, controls the database upgrade within the scope of a single table, and only upgrades the tables that need to be updated.

The present application has beneficial technical effects described below.
1. The present application enables online upgrade of file-based databases in a distributed storage system, in other words, read and write operations on the database are not affected during the upgrade process of the distributed storage system.
2. It is allowed to use different database rollback strategies at different upgrade phases, thereby reducing the impact of database or upgrade failures on business operations.
3. Mutual conversion between old and new database structures is achieved, enabling automatic switching between old and new structures as needed and responding accordingly. This ensures that queries and writes at old and new interface can be executed normally during the upgrade.
4. The normal data read and write operations during the upgrade of the distributed storage system is achieved through a redirection interface. The data converter and the redirection interface cooperate with each other to achieve seamless data querying. In other words, the redirection interface can automatically switch between the old and new data structures and respond based on the upgrade status of the external interface.
5. New data is cached by a data cache and the cached data can be serialized according to the structure of the source database.
6. Operations required for database upgrade are minimized, the database upgrade is controlled within the scope of a single table, and only tables required to be updated are upgraded.

It should be particularly pointed out that steps in the various embodiments of the method for upgrading and optimizing file-based databases can be crossed, replaced, added, or deleted. Therefore, these reasonable permutations and combinations of the method for upgrading and optimizing file-based databases should also belong to the protection scope of the present application, and the protection scope of the present application should not be limited to the embodiments.

Based on the above object, in a second aspect of some embodiments of the present application, a system for upgrading and optimizing a file-based database is proposed. As shown in FIG. 5, the system 200 includes: a monitoring module, configured to distribute a node controller to each node through a main controller, install and activate the node controller on each node, and monitor the state of each node controller in a heartbeat manner; a strategy module, configured to formulate a database upgrade strategy according to the concurrent upgrade strategy of the distributed storage system; and an execution module, configured to perform online upgrade on the file-based database of each node by the node controller according to the database upgrade strategy.

In some embodiments, the system further includes a rollback module configured to trigger different rollback strategies by the main controller according to different upgrade phases.

In some embodiments, the rollback module is configured to: in response to an exception occurring during the database upgrade phase, directly replace the content of the source database with the temporary database and block the upgrade of the node storage system.

In some embodiments, the rollback module is configured to: in response to an exception occurring in the upgrade of a node in the node distributed storage system, trigger degradation, roll back the database table structure to the database table structure before the upgrade while retaining the newly written data during the upgrade.

In some embodiments, the rollback module is configured to: in response to the upgrade failure of the cluster of the distributed storage system, trigger forced rollback, through which the main controller forces databases of all nodes to roll back to the state before the upgrade.

In some embodiments, the execution module is configured to set an upgrade flag in the database, and trigger the database operation interface to redirect according to the upgrade flag so as to redirect all database operation commands to the redirection interface of the node controller for processing.

In some embodiments, the execution module is configured to write all data issued through redirection that is written during the database upgrade into the data cache.

In some embodiments, the execution module is configured to generate a temporary database by copying the file-based database, and provide data query services to the outside during the database upgrade by using the temporary database as the main database.

In some embodiments, the execution module is configured to adjust tables with changed data structures in the source database, and flush the data in the data cache to the source database according to the new data structure.

In some embodiments, the execution module is configured to perform read and write tests on the source database and the tables with changed structures. If the test is abnormal, the rollback is performed directly by using the temporary database.

In some embodiments, the execution module is configured to directly read and write the source database by the node controller after the upgrade of the source database is completed.

In some embodiments, the execution module is configured to remove the upgrade flag by the node controller after the upgrade of the file-based database is completed, and restore the database operation interface to the normal operation process.

In some embodiments, the system further includes a conversion module configured to record both of the table structure data information of the new database and the old database by the node controller, and convert the information into data information that meets the requirements of the redirection interface for response based on the table structure information of the new database and the old database.

In some embodiments, the system further includes a switching module configured to automatically switch between the temporary database and the source database through the redirection interface of the node controller according to the database upgrade state.

In some embodiments, the system further includes a response module configured to receive data written from the outside through the redirection interface of the node controller, save the data to the data cache, and assemble the data in the database buffer and the data in the temporary database by the redirection interface to respond to external read operations.

In some embodiments, the system further includes a cache module that is configured to cache newly added data through the data cache of the node controller and serialize the cached data according to the structure of the source database.

In some embodiments, the system further includes an upgrade module configured to upgrade the data structure of the source database and update data by the upgrade controller of the node controller.

Based on the above objects, a third aspect of some embodiments of the present application proposes a computer device, including: at least one processor; and a memory, where the memory is stored with computer instructions that can run on the processor, and the instructions are executed by the processor to implement the following steps. At S1, a main controller distributes a node controller to each node, the node controller is installed and activated on each node, and monitors the state of each node controller in a heartbeat manner. At S2, a database upgrade strategy is formulated according to a concurrent upgrade strategy of the distributed storage system. At S3, online upgrade of the file-based database of each node is performed by the node controller according to the database upgrade strategy.

In some embodiments, the processor may further implement a step of: triggering different rollback strategies by the main controller according to different upgrade phases.

In some embodiments, triggering different rollback strategies by the main controller according to different upgrade phases includes: in response to an exception occurring during the database upgrade phase, directly replacing the content of the source database with the temporary database and blocking the upgrade of the node storage system.

In some embodiments, triggering different rollback strategies by the main controller according to different upgrade phases includes: in response to an exception occurring in the upgrade of a node in the node distributed storage system, triggering degradation, through which the database table structure is rolled back to that before the upgrade, and the newly written data during the upgrade is retained.

In some embodiments, triggering different rollback strategies by the main controller according to different upgrade phases includes: in response to the upgrade failure of the cluster of the distributed storage system, triggering forced rollback, through which the main controller forces databases of all nodes to roll back to the state before the upgrade.

In some embodiments, the step, in which online upgrade of the file-based database of each node is performed by the node controller according to the database upgrade strategy, includes: setting an upgrade flag in the database, and triggering the database operation interface to redirect according to the upgrade flag so as to redirect all database operation commands to the redirection interface of the node controller for processing.

In some embodiments, the step, in which online upgrade of the file-based database of each node is performed by the node controller according to the database upgrade strategy, includes: writing all data issued from redirection that is written during database upgrade into a data cache.

In some embodiments, the step, in which online upgrade of the file-based database of each node is performed by the node controller according to the database upgrade strategy, includes: generating a temporary database by copying the file-based database, and providing data query services to the outside during the database upgrade by using the temporary database as the main database.

In some embodiments, the step, in which online upgrade of the file-based database of each node is performed by the node controller according to the database upgrade strategy, includes: adjusting the tables with changed data structures in the source database, and flushing the data in the data cache to the source database according to the new data structure.

In some embodiments, the step, in which online upgrade of the file-based database of each node is performed by the node controller according to the database upgrade strategy, includes: performing read and write tests on the source database and the tables with changed structures. If the test is abnormal, the temporary database is directly used for rollback.

In some embodiments, the step, in which online upgrade of the file-based database of each node is performed by the node controller according to the database upgrade strategy, includes: directly reading and writing the source database by the node controller after the upgrade of the source database is completed.

In some embodiments, the step, in which online upgrade of the file-based database of each node is performed by the node controller according to the database upgrade strategy, includes: after the upgrade of the file-based database is completed, removing the upgrade flag by the node controller, and restoring the database operation interface to the normal operation process.

In some embodiments, the processer further implements steps of: recording both of the data information about the table structures of the new database and the old database by the node controller, and converting the information into data information that meets the requirements of the redirection interface for response based on the table structure information of the new database and the old database.

In some embodiments, the processer further implements steps of: automatically switching between the temporary database and the source database by the redirection interface of the node controller according to the database upgrade state.

In some embodiments, the processer further implements steps of: receiving data written from the outside through the redirection interface of the node controller, saving the data to the data cache, and assembling the data in the database buffer and the data in the temporary database by the redirection interface to respond to external read operations.

In some embodiments, the processer further implements steps of: caching newly added data by the data cache of the node controller, and serializing the cached data according to the structure of the source database.

In some embodiments, the processer further implements steps of: upgrading the data structure of the source database and updating data by the upgrade controller of the node controller.

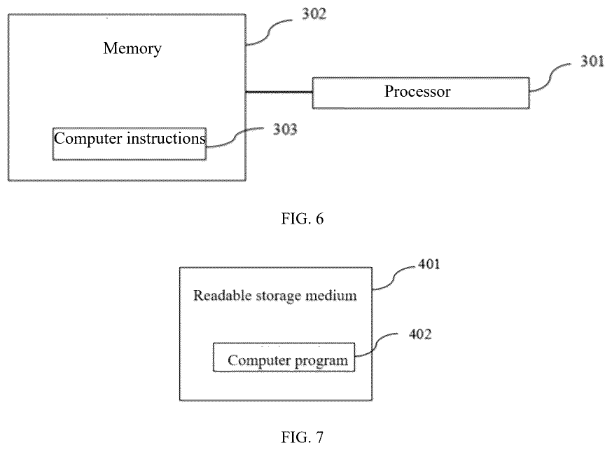

FIG. 6 is a schematic hardware structural diagram of a computer device for upgrading and optimizing the file-based database provided by an embodiment of the present application.

Taking the device as shown in FIG. 6 as an example, the device includes a processor 301 and a memory 302.

The processor 301 and the memory 302 can be connected through a bus or in other ways. In FIG. 6, the processor 301 and the memory 302 are connected through the bus.

The memory 302 is a non-transitory readable storage medium, and can be used to store non-transitory software programs, non-transitory computer-executable programs and modules, such as program instructions/modules corresponding to the method for upgrading and optimizing the file-based database in some embodiments of the present application. The processor 301 executes various functional applications and data processing of the server by running the non-transitory software programs, instructions and modules stored in the memory 302, that is, implements the method for upgrading and optimizing the file-based database.

The memory 302 may include a program storage area and a data storage area. The program storage area can store an operating system and at least one application program required by functions; the data storage area can store data created according to the use of the method for upgrading and optimizing the file-based database, etc. In addition, the memory 302 may include a high-speed random access memory, and may also include a non-transitory memory, such as at least one magnetic disk storage device, a flash memory device, or other non-transitory solid-state storage devices. In some embodiments, the memory 302 may optionally include a memory remotely arranged relative to the processor 301, and these remote memories can be connected to the local module through a network. Examples of the network include but are not limited to the Internet, an enterprise intranet, a local area network, a mobile communication network and combinations thereof.

One or more computer instructions 303 corresponding to the method for upgrading and optimizing the file-based database are stored in the memory 302. When these computer instructions are executed by the processor 301, the method for upgrading and optimizing the file-based database in any of the above method embodiments is executed.

The computer device for executing the method for upgrading and optimizing the file-based database according to any embodiments described above can achieve the same or similar effects as any of the aforementioned method embodiments corresponding thereto.

The present application also provides a non-transitory readable storage medium storing a computer program that when executed by a processor, implements the method for upgrading and optimizing the file-based database.

FIG. 7 is a schematic diagram a non-transitory readable storage medium for upgrading and optimizing the file-based database provided in some embodiments of the present application. Taking the non-transitory readable storage medium as shown in FIG. 7 as an example, the non-transitory readable storage medium 401 is stored with a computer program 402 that when executed by a processor, executes the above method.

Finally, it should be noted that those skilled in the art can understand that all or part of the processes in the methods of the above embodiments can be completed by instructing relevant hardware through a computer program. The program of the method for upgrading and optimizing the file-based database can be stored in a non-transitory readable storage medium. When the program is executed, it can include the processes of the embodiments of the above methods. The storage medium of the program can be a magnetic disk, an optical disk, a read-only memory (ROM, Read-Only Memory) or a random access memory (RAM, Random Access Memory), etc. The embodiments of the above computer program can achieve the same or similar effects as any of the method embodiments corresponding thereto.

The above are exemplary embodiments disclosed in the present application. However, it should be noted that various changes and modifications can be made without departing from the scope of the disclosure of the embodiments of the present application as defined by the claims. The functions, steps and/or actions of the method claims according to the disclosed embodiments of the present application do not need to be executed in any specific order. In addition, although elements disclosed in the present application can be described or claimed in an individual form, unless explicitly limited to a singular form, they can also be understood as multiple.

It should be understood that unless the context clearly supports exceptions, the singular form “a” is intended to include the plural form. It should also be understood that “and/or” used herein refers to any and all possible combinations including one or more of the associated listed items.

The serial numbers of the disclosed embodiments of the above application are only for description, and do not represent the advantages or disadvantages of the embodiments.

Those skilled in the art can understand that all or part of the steps for implementing the above embodiments can be completed by hardware, or by a program instructing relevant hardware. The program can be stored in a non-transitory readable storage medium. The above-mentioned storage medium can be a read-only memory, a magnetic disk or an optical disk, etc.

Those skilled in the art should understand that any discussion of the above embodiments is only exemplary, and is not intended to imply that the scope of the disclosure of the embodiments of the present application (including the claims) is limited to these examples; under the idea of the embodiments of the present application, technical features in the above embodiments or in different embodiments can also be combined, and there are many other changes in different aspects of the embodiments of the present application as described above, which are not provided in details for the sake of brevity. Therefore, any omissions, modifications, equivalent substitutions, improvements, etc. within the spirit and principles of the embodiments of the present application should be included in the protection scope of the embodiments of the present application.

1. A method for upgrading and optimizing a file-based database, comprising:
distributing, by a main controller, a node controller to each node, installing and activating the node controller on each node, and monitoring a state of each said node controller in a heartbeat manner;
formulating a database upgrade strategy according to a concurrent upgrade strategy of a distributed storage system; and
performing, by each said node controller, online upgrade on the file-based database of each node according to the database upgrade strategy;
wherein the performing, by each said node controller, online upgrade on the file-based database of each node according to the database upgrade strategy comprises:
setting an upgrade flag in the database, and triggering a database operation interface to redirect according to the upgrade flag to redirect all database operation commands to a redirection interface of the node controller for processing;
writing all data issued from redirection that is written during database upgrade into a data cache;
generating a temporary database by copying the file-based database, and providing data query services to the outside during the database upgrade by using the temporary database as a main database; and
adjusting tables with changed data structures in a source database, and flushing the data in the data cache to the source database according to the adjusted data structures.

2. The method according to claim 1, further comprising:
triggering, by the main controller, different rollback strategies according to different upgrade phases.

3. The method according to claim 2, wherein the triggering, by the main controller, different rollback strategies according to different upgrade phases comprises:
in response to an exception occurring during a database upgrade phase, replacing contents of the source database with the temporary database directly and blocking the upgrade of nodes in the storage system.

4. The method according to claim 2, wherein the triggering, by the main controller, different rollback strategies according to different upgrade phases comprises:
in response to an exception occurring in the upgrade of nodes in the distributed storage system, triggering degradation, rolling back a table structure of the database to the table structure before the upgrade and retaining newly written data during the upgrade.

5. The method according to claim 2, wherein the triggering, by the main controller, different rollback strategies according to different upgrade phases comprises:
in response to an upgrade failure of a cluster of the distributed storage system, triggering a forced rollback, and forcing, by the main controller, databases of all nodes to roll back to the state before the upgrade.

6-9. (canceled)

10. The method according to claim 91, wherein the performing, by each said node controller, online upgrade on the file-based database of each node according to the database upgrade strategy comprises:
performing read and write tests on the source database and the tables with changed structures; and
performing rollback directly by using the temporary database in response to the tests being abnormal.

11. The method according to claim 10, wherein the performing, by each said node controller, online upgrade on the file-based database of each node according to the database upgrade strategy comprises:
directly reading and writing the source database by the node controller after the upgrade of the source database is completed.

12. The method according to claim 11, wherein the performing, by each said node controller, online upgrade on the file-based database of each node according to the database upgrade strategy comprises:
removing, by the node controller, the upgrade flag after the upgrade of the file-based database is completed, and switching the database operation interface to a normal operation process.

13. The method according to claim 1, further comprising:
recording, by each said node controller, data information about the table structure of a new database and an old database, and converting, based on the information about the table structures of the new database and the old database, information into data information that meets requirements of the redirection interface for response.

14. The method according to claim 13, further comprising:
automatically switching, by the redirection interface of the node controller, between the temporary database and the source database according to the state of database upgrade.

15. The method according to claim 14, further comprising:
receiving, by the redirection interface of the node controller, data written from the outside, saving the data to the data cache, and assembling, by the redirection interface, the data in the database cache and the data in the temporary database to respond to external read operations.

16. The method according to claim 15, further comprising:
caching, by the data cache of the node controller, newly added data, and serializing the data cached according to the structure of the source database.

17. The method according to claim 16, further comprising:
upgrading, by an upgrade controller of the node controller, the data structure of the source database and updating data.

18. (canceled)

19. A computer device, comprising:
at least one processor; and
a memory, wherein the memory is stored with computer executable instructions that when executed by the processor, implement steps of the method according to claim 1.

20. A non-transitory computer readable storage medium storing a computer program that when executed by a processor, implements steps of the method according to-any claim 1.

21. The computer device according to claim 19, wherein the processor further is configured to execute the computer executable instructions to implement operations of:
triggering, by the main controller, different rollback strategies according to different upgrade phases.

22. The computer device according to claim 21, wherein the processor further is configured to execute the computer executable instructions to implement operations of:
in response to an exception occurring during a database upgrade phase, replacing contents of the source database with the temporary database directly and blocking the upgrade of nodes in the storage system.

23. The computer device according to claim 21, wherein the processor further is configured to execute the computer executable instructions to implement operations of:
in response to an exception occurring in the upgrade of nodes in the distributed storage system, triggering degradation, rolling back a table structure of the database to the table structure before the upgrade and retaining newly written data during the upgrade.

24. The computer device according to claim 21, wherein the processor further is configured to execute the computer executable instructions to implement operations of:
in response to an upgrade failure of a cluster of the distributed storage system, triggering a forced rollback, and forcing, by the main controller, databases of all nodes to roll back to the state before the upgrade.

25. The computer device according to claim 19, wherein the processor further is configured to execute the computer executable instructions to implement operations of:
performing read and write tests on the source database and the tables with changed structures; and
performing rollback directly by using the temporary database in response to the tests being abnormal.
